(19) United States
(12) Patent Application Publication
(10) Pub. No.: US 2025/0043069 A1
(43) Pub. Date: Feb. 6, 2025

(54) SEMI-AROMATIC POLYESTER, AND PREPARATION METHOD THEREFOR AND APPLICATION THEREOF

(71) Applicants: JIANGSU KINGFA SCI & TECH. ADVANCED MATERIALS CO., LTD., Jiangsu (CN); ZHUHAI KINGFA BIOMATERIAL CO., LTD., Guangdong (CN); KINGFA SCI. & TECH. CO., LTD., Guangdong (CN)

(72) Inventors: Chuanhui ZHANG, Jiangsu (CN); Pingxu CHEN, Jiangsu (CN); Nanbiao YE, Jiangsu (CN); Chunping OUYANG, Jiangsu (CN); Kaijin MAI, Jiangsu (CN); Xueteng DONG, Jiangsu (CN); Xiangbin ZENG, Jiangsu (CN); Changli LU, Jiangsu (CN); Tongmin CAI, Jiangsu (CN)

(73) Assignees: JIANGSU KINGFA SCI & TECH. ADVANCED MATERIALS CO., LTD., Jiangsu (CN); ZHUHAI KINGFA BIOMATERIAL CO., LTD., Guangdong (CN); KINGFA SCI. & TECH. CO., LTD., Guangdong (CN)

(21) Appl. No.: 18/704,931

(22) PCT Filed: Sep. 23, 2022
(86) PCT No.: PCT/CN2022/120721

§ 371 Date: Apr. 26, 2024

(30) Foreign Application Priority Data
Oct. 26, 2021 (CN) 202111248549.9

(51) Int. Cl. C08G 63/183; C08G 63/20; C08G 63/78

(52) U.S. Cl. CPC C08G 63/183; C08G 63/20; C08G 63/785

(57) ABSTRACT

The present invention discloses a semi-aromatic polyester, and a preparation method therefor and an application thereof. The semi-aromatic polyester has a specific scope of double bond content. Compared with the existing semi-aromatic polyester, the semi-aromatic polyester of the present invention has better melting heat retention stability and fine color.

### TECHNICAL FIELD

The present invention relates to the field of biodegradable polyester, and in particular to a semi-aromatic polyester having a specific double bond content, and a preparation method therefor and an application thereof.

### BACKGROUND OF RELATED ART

A biodegradable aliphatic-aromatic copolyester can be prepared by aliphatic diacids or derivatives thereof, aliphatic diols, aromatic diacids or derivatives thereof. Represented by Ecoflex produced by Germany BASF, the copolyester is made of raw materials of 1,6-adipic acid (AA), 1,4-butanediol (BDO) and terephthalic acid. The copolyester has a lower melt volume flow rate (MVR) and thus, has excellent machinability, and further has good hydrolysis resistance due to a low acid value. However, relative to aromatic polyesters PET, PBT, and the like, the semi-aromatic polyester is more likely to thermal decomposition to generate double bonds, carboxyl group and other structures after thermal degradation, thus resulting in worsened properties of polymerization products, which is against the further use.

### SUMMARY OF THE INVENTION

To solve the above problems, the objective of the present invention is to provide a semi-aromatic polyester. With a specific double bond content, the semi-aromatic polyester has better melting heat retention stability and fine color.

Another objective of the present invention is to provide a preparation method of the above semi-aromatic polyester.

The above objectives of the present invention are achieved by the following technical solutions.

A semi-aromatic polyester, derived from a repeating unit consisting of the following components:
a first component A, based on a total molar weight of the first component A, including:
a1) 40-60 mol % of at least one aliphatic dicarboxylic acid or a derivative thereof;
a2) 40-60 mol % of at least one aromatic dicarboxylic acid or a derivative thereof;
a second component B: including a diol having 2-12 carbon atoms;
where the semi-aromatic polyester has a double bond content of 0.55-4.5 mmol/kg, preferably, 0.70-2.5 mmol/kg, and more preferably, 0.75-0.95 mmol/kg.

During the synthesis of a polyester, there exists a larger difference in the molecular structure of the polyester prepared finally due to the influences of multiple factors such as, different monomer structures or ratios of raw materials, different kinds of catalysts, branching agents and chain extenders, preparation technology, reaction time and polymerization temperature. In this present invention, it has been found through studies that the double bond content in the semi-aromatic polyester is closely related to the melting heat retention stability and color of the semi-aromatic polyester.

In this present invention, it has been accidentally found through studies that when the double bond content in the semi-aromatic polyester is controlled within a range of 0.55-4.5 mmol/kg, the obtained semi-aromatic polyester has better melting heat retention stability and fine color.

In this present invention, the component a1), namely the aliphatic dicarboxylic acid or a derivative thereof is selected from one or a mixture of several of oxalic acid, propandioic acid, succinic acid, glutaric acid, adipic acid, heptanedioic acid, octanedioic acid, azelaic acid, decanedioic acid, 1,11-undecanedicarboxylic acid, 1,10-decanedicarboxylic acid, undecandioic acid, 1,12-dodecanedicarboxylic acid, hexadecane diacid, eicosandioic acid, tetracosandioic acid or an ester derivative thereof or an anhydride derivative thereof.

As a specific example, the component a1) is selected from one or more of oxalic acid, dimethyl oxalate, malonic acid, dimethyl malonate, succinic acid, dimethyl succinate, methylsuccinic acid, glutaric acid, dimethyl glutarate, bis(2-hydroxyethyl) glutarate, bis(3-hydroxypropyl) glutarate, bis(4-hydroxybutyl) glutarate, 2-methylglutaric acid, 3-methylglutaric acid, adipic acid, dimethyl adipate, bis(2-hydroxyethyl)adipate, bis(3-hydroxypropyl)adipate, bis(4-hydroxybutyl)adipate, 3-methyladipic acid, 2,2,5,5-tetramethyladipic acid, heptanedioic acid, octanedioic acid, azelaic acid, dimethyl azelate, decanedioic acid, 1,11-undecanedicarboxylic acid, 1,10-decanedicarboxylic acid, undecandioic acid, 1,12-dodecanedicarboxylic acid, hexadecane diacid, eicosandioic acid, tetracosandioic acid, dimer acid or an ester derivative thereof or an anhydride derivative thereof; preferably, one or more of succinic acid, adipic acid, decanedioic acid, 1,12-dodecanedicarboxylic acid, or an ester derivative thereof or an anhydride derivative thereof; more preferably, one or two of adipic acid, decanedioic acid or an ester derivative thereof or an anhydride derivative thereof; most preferably, adipic acid or an ester derivative thereof or an anhydride derivative thereof.

In the present invention, the component a2), namely, the aromatic dicarboxylic acid or a derivative thereof is selected from one or a mixture of several of terephthalic acid, iso-phthalic acid, naphthalenedicarboxylic acid, or an ester derivative thereof or an anhydride derivative thereof; preferably, terephthalic acid or an ester derivative thereof or an anhydride derivative thereof.

As a specific example, the component a2) is selected from one or more of terephthalic acid, dimethyl terephthalate, bis(2-hydroxyethyl)terephthalate, bis(3-hydroxypropyl)terephthalate, bis(4-hydroxybutyl)terephthalate, iso-phthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl 2, 6-phthalate, 2,7-naphthalene dicarboxylic acid, dimethyl 2, 7-phthalate, 3,4′-diphenyl ether dicarboxylic acid, dimethyl 3,4′-oxybisbenzoate, 4,4′-diphenyl ether dicarboxylic acid, dimethyl 4,4′-oxybisbenzoate, 3,4′-phenyl thioether dicarboxylic acid, dimethyl 3,4′-thioether bisbenzoate, 4,4′-diphenyl thioether dicarboxylic acid, dimethyl 4,4′-thioether bisbenzoate, 3,4′-diphenylsulfone dicarboxylic acid, dimethyl 3,4′-sulfonyl bisbenzoate, 4,4′-diphenylsulfone dicarboxylic acid, dimethyl 4,4′-sulfonyl bisbenzoate, 3,4′-benzophenone dicarboxylic acid, dimethyl 3,4′-ketone bisbenzoate, 4,4′-benzophenone dicarboxylic acid, dimethyl 4,4′-ketone bisbenzoate, 1,4-naphthalene dicarboxylic acid, dimethyl 1,4-naphthalate, 4,4′-methylene-bis(benzoic acid), 4,4′-methylene-bis(dimethyl benzoate) or an ester derivative thereof or an anhydride derivative thereof; preferably, terephthalic acid or an ester derivative thereof or an anhydride derivative thereof.

In the present invention, the second component B is selected from one or more of ethanediol, 1,3-propanediol, 1,4-butanediol, 1,5-pentanediol, 1,6-hexanediol, 1,9-nonanediol, 1,10-decanediol, 1,11-undecanediol, 1,12-dodecanediol, 1,4-cyclohexanediol, and 1,4-cyclohexanedimethanol; preferably, ethanediol, 1,3-propanediol, or 1,4-butanediol.

Most preferably, when the component a1) is adipic acid or the ester derivative thereof or the anhydride derivative thereof, the component a2) is terephthalic acid or the ester derivative thereof or the anhydride derivative thereof; and the second component B is a combination of 1,4-butanediol.

Based on the total molar weight of the first component A, the semi-aromatic polyester of the present invention includes a third component C of 0.01-5.0 mol %, and a fourth component D of 0.01-5.0 mol %.

The third component C is selected from one or more of tartaric acid, citric acid, malic acid, trimethylolpropane, trimethylolethane, pentaerythritol, polyether triol, glycerol, 1,3,5-trimesic acid, 1,2,4-trimesic acid, 1,2,4-trimellitic anhydride, 1,2,4,5-prenitic acid or pyromellitic dianhydride; preferably, trimethylolpropane, pentaerythritol, or glycerol.

The fourth component D is a chain extender; the chain extender is one or a mixture of several of isocyanate, isocyanurate, peroxide, epoxide, oxazoline, oxazine, lactam, carbodiimide or polycarbodiimide which contains two or more functional groups.

The isocyanate which contains two or more functional groups may be an aromatic isocyanate or an aliphatic isocyanate; preferably, an aromatic diisocyanate or an aliphatic diisocyanate. Preferably, the aromatic diisocyanate is toluene 2,4-diisocyanate, toluene 2,6-diisocyanate, diphenylmethane 2,2′-diisocyanate, diphenylmethane 2,4′-diisocyanate, diphenylmethane 4,4′-diisocyanate, naphthalene 1,5-diisocyanate or xylene diisocyanate.

More preferably, the aromatic diisocyanate is diphenylmethane 2,2′-diisocyanate, diphenylmethane 2,4′-diisocyanate or diphenylmethane 4,4′-diisocyanate.

The isocyanate which contains two or more functional groups may be further tri(4-isocyanato-phenyl) methane with three rings.

Preferably, the aliphatic diisocyanate is preferably any linear-chain or branched-chain alkylene diisocyanate or cycloalkylene diisocyanate containing 2-20 carbon atoms, more preferably, containing 3-12 carbon atoms. The aliphatic diisocyanate may be hexamethylene 1, 6-diisocyanate, isophorone diisocyanate or methylene di(4-isocyanato-cyclohexane); most preferably, hexamethylene 1, 6-diisocyanate, or isophorone diisocyanate.

Preferably, the isocyanurate which contains two or more functional groups is an aliphatic isocyanurate, and derived from alkylene diisocyanate or cycloalkylene diisocyanate having 2-20 carbon atoms, preferably, 3-12 carbon atoms, for example, isophorone diisocyanate or methylene di(4-isocyanato-cyclohexane). The alkylene diisocyanate may be a linear-chain or branched-chain compound; especially preferably, an isocyanurate based on a cyclic trimer, a pentamer or higher oligomer of n-hexamethylene diisocyanate, for example, hexamethylene 1,6-diisocyanate.

Preferably, the peroxide which contains two or more functional groups is preferably, benzoyl peroxide, 1,1-di(tert-butylperoxo)-3,3,5-trimethylcyclohexane, 1,1-di(tert-butylperoxo)methylcyclododecane, n-butyl 4,4-di(butylperoxo)pentanoate, dicumyl peroxide, tert-butyl peroxybenzoate, dibutyl peroxide, α,α-di(tert-butyl peroxo)diisopropyl benzene, 2,5-dimethyl-2,5-di(tert-butyl peroxo)hexane, 2,5-dimethyl-2,5-di(tert-butyl peroxo)hex-3-alkyne or tert-butyl cumene peroxide.

Preferably, the epoxide which contains two or more functional groups is preferably, hydroquinone, diglycidyl ether, resorcinol diglycidyl ether, 1,6-hexanediol diglycidyl ether, hydrogenated bisphenol A diglycidyl ether, diglycidyl terephthalate, diglycidyl tetrahydrophthalate, diglycidyl hexahydrophthalate, dimethyl diglycidyl phthalate, phenylene diglycidyl ether, ethylidene diglycidyl ether, trimethylene diglycidyl ether, tetramethylene diglycidyl ether, hexamethylene diglycidyl ether, sorbitol diglycidyl ether, polyglycerol polyglycidyl ether, pentaerythritol polyglycidyl ether, diglycerol polyglycidyl ether, glycerin polyglycidyl ether, trimethylolpropane polyglycidyl ether, resorcinol diglycidyl ether, neopentyl glycol diglycidyl ether, glycol diglycidyl ether, diglycol diglycidyl ether, polyethylene glycol diglycidyl ether, propylene glycol diglycidyl ether, dipropylene glycol diglycidyl ether, polypropylene glycol diglycidyl ether, or poly1,4-butanediol diglycidyl ether.

The epoxide which contains two or more functional groups is further preferably a copolymer containing an epoxy group and based on styrene, acrylate and/or methacrylate; the epoxy group is preferably glycidyl methacrylate. It has been proved that a favorable compound is a copolymer in which a ratio of the glycidyl methacrylate is higher than 20 wt %, more preferably, higher than 30 wt %, and further preferably, higher than 50 wt %. In these polymers, the epoxide equivalent weight is preferably 150-3000 g/equivalent, more preferably, 200-500 g/equivalent. The weight-average molecular weight (Mw) of the polymer is preferably 2000-25000, more preferably 3000-8000. The number-average molecular weight (Mn) of the polymer is preferably 400-6000, more preferably 1000-4000. Polydispersity index (Q=Mw/Mn) is preferably 1.5-5.

The oxazoline or oxazine which contains two or more functional groups is preferably dioxazoline or dioxazine; the bridging portion thereof is a single bond, or (CH₂)z-alkylene, in which z 2, 3 or 4, for example, methylene, et-1,2-diyl, propyl-1,3-diyl, or propyl-1,2-diyl, or phenylene. Specifically, the dioxazoline is 2,2′-di(2-oxazoline), di(2-oxazolinyl)methane, 1,2-di(oxazolinyl)ethane, 1,3-di(2-oxazolinyl)propane, 1,4-di(2-oxazolinyl)butane, 2,2′-di(2-oxazoline), 2,2′-di(4-methyl-2-oxazoline), 2,2′-di(4,4′-dimethyl-2-oxazoline), 2,2′-di(4-ethyl-2-oxazoline), 2,2′-di(4,4′-diethyl-2-oxazoline), 2,2′-di(4-propyl-2-oxazoline), 2,2′-di(4-butyl-2-oxazoline), 2,2′-di(4-hexyl-2-oxazoline), 2,2′-di(4-phenyl-2-oxazoline), 2,2′-di(4-cyclohexyl-2-oxazoline), 2,2′-di(4-benzyl-2-oxazoline), 2,2′-p-phenylene-di(4-methyl-2-oxazoline), 2,2′-p-phenylene-di(4,4′-dimethyl-2-oxazoline), 2,2′-m-phenylene-di(4-methyl-2-oxazoline), 2,2′-m-phenylene-di(4,4′-dimethyl-2-oxazoline), 2,2′-hexamethylene-di(2-oxazoline), 2,2′-octamethylene-di(2-oxazoline), 2,2′-decamethylene-di(2-oxazoline), 2,2′-ethylidene-di(4-methyl-2-oxazoline), 2,2′-tetramethylene-di(4,4′-dimethyl-2-oxazoline), 2,2′-9,9′-diphenoxyethane-di(2-oxazoline), 2,2′-cyclohexylidene-di(2-oxazoline), or 2,2′-diphenylene(2-oxazoline).

More preferably, the dioxazoline is 1,4-di(2-oxazolinyl)benzene, 1,2-di(2-oxazolinyl)benzene, or 1,3-di(2-oxazolinyl)benzene.

Specifically, dioxazine is 2,2′-di(2-dioxazine), di(2-dioxazinyl)methane, 1,2-di(2-dioxazinyl)ethane, 1,3-di(2-dioxazinyl)propane, 1,4-di(2-dioxazinyl)butane, 1,4-di(2-dioxazinyl)benzene, 1,2-di(2-dioxazinyl)benzene, or 1,3-di(2-dioxazinyl)benzene.

The carbodiimide or the polycarbodiimide which contains two or more functional groups is preferably N,N′-di-2,6-diisopropylphenyl carbodiimide, N,N′-di-o-tolyl carbodiimide, N,N′-diphenyl carbodiimide, N,N′-dioctyldecyl carbodiimide, N,N′-di-2,6-dimethylphenyl carbodiimide, N-tolyl-N′-cyclohexyl carbodiimide, N,N′-di-2,6-di-tert-butylphenyl carbodiimide, N-tolyl-N′-phenyl carbodiimide, N,N′-di-p-nitrophenyl carbodiimide, N,N′-di-p-aminophenyl carbodiimide, N,N′-di-p-hydroxylphenyl carbodiimide, N,N′-dicyclohexylcarbodiimide, N,N′-di-p-tolyl carbodiimide, p-phenylene-bis-di-o-tolyl carbodiimide, p-phenylene-bis-dicyclohexyl carbodiimide, hexamethylene-bis-dicyclohexyl carbodiimide, 4,4′-dicyclohexyl methane carbodiimide, ethylidene-bis-diphenyl carbodiimide, N,N′-tolyl-carbodiimide, N-octadecyl-N′-phenyl carbodiimide, N-benzyl-N′-phenyl carbodiimide, N-octadecyl-N′-tolyl carbodiimide, N-cyclohexyl-N′-tolyl carbodiimide, N-phenyl-N′-tolyl carbodiimide, N-benzyl-N′-tolyl carbodiimide, N,N′-di-o-ethylphenyl carbodiimide, N,N′-di-p-ethylphenyl carbodiimide, N,N′-di-o-isopropylphenyl carbodiimide, N,N′-di-p-isopropylphenyl carbodiimide, N,N′-di-o-isobutylphenyl carbodiimide, N,N′-di-p-isobutylphenyl carbodiimide, N,N′-di-2,6-diethylphenyl carbodiimide, N,N′-di-2-ethyl-6-isopropylphenyl carbodiimide, N,N′-di-2-isobutyl-6-isopropylphenyl carbodiimide, N,N′-di-2,4,6-trimethylphenyl carbodiimide, N,N′-di-2,4,6-triisopropylphenyl carbodiimide, N,N′-di-2,4,6-triisobutylphenyl carbodiimide, diisopropyl carbodiimide, dimethyl carbodiimide, diisobutyl carbodiimide, dioctyl carbodiimide, tert-butylisopropyl carbodiimide, di-β-naphthyl carbodiimide or di-tert-butyl carbodiimide.

Preferably, the semi-aromatic polyester has a viscosity number of 150-350 ml/g; the viscosity number is determined in a phenol/o-dichlorobenzene solution having a weight ratio of 1:1 and a thermostatic water bath at 25±0.05° C. in accordance with the regulations of GB/T 17931-1999.

Preferably, the semi-aromatic polyester has a carboxyl group content of 5-60 mmol/kg, preferably, 10-30 mmol/kg.

The present invention further provides a preparation method of the above semi-aromatic polyester, including the following steps:
step S1: adding the a1 in the first component A and the second component B to a slurry preparation kettle by a proportion, and transporting the prepared slurry to a first esterification reactor, then adding the second component B returned and a catalyst to the first esterification reactor from another pathway, and performing esterification reaction for 2-4 h at 150-200° C. and 30-110 kPa to obtain an esterified product Ba1; adding the a2 in the first component A and the second component B to a slurry preparation kettle, and transporting the prepared slurry to a second esterification reactor, then adding the second component B returned and a catalyst to the second esterification reactor from another pathway, and performing esterification reaction for 2-4 h at 200-250° C. and 30-110 kPa to obtain an esterified product Ba2;
step S2: performing primary polycondensation on the esterified product Ba1 in the step St at a reaction temperature of 170-220° C. and a pressure of 1-10 kPa; performing primary polycondensation on the esterified product Ba2 in the step St at a reaction temperature of 230-270° C. and a pressure of 1-10 kPa; performing the primary polycondensation on the esterified products Ba1 and Ba2 independently and respectively until each reaction product has a viscosity number of 15-60 ml/g, where the viscosity number is determined in a phenol/o-dichlorobenzene solution having a weight ratio of 1:1 and a thermostatic water bath at 25±0.05° C. in accordance with the regulations of GB/T 17931-1999, thus respectively obtaining products Pre-Ba1 and Pre-Ba2 of the primary polycondensation;
step S3: transferring the product Pre-Ba1 of the primary polycondensation obtained in the step S2 to a first final-polycondensation kettle at a reaction temperature of 180-230° C. and a pressure of 10-500 Pa; transferring the product Pre-Ba2 of the primary polycondensation obtained in the step S2 to a second final-polycondensation kettle at a reaction temperature of 220-270° C. and a pressure of 10-500 Pa; performing polycondensation on the products Pre-Ba1 and Pre-Ba2 independently and respectively until each reaction product has a viscosity number of 50-180 ml/g, where the viscosity number is determined in a phenol/o-dichlorobenzene solution having a weight ratio of 1:1 and a thermostatic water bath at 25±0.05° C. in accordance with the regulations of GB/T 17931-1999, thus respectively obtaining the final-polycondensation products Poly-Ba1 and Poly-Ba2;
step S4: performing mixed reaction on the final-polycondensation products Poly-Ba1 and Poly-Ba2 obtained in the step S3 in a mixer to obtain the semi-aromatic polyester such that the semi-aromatic polyester has a viscosity number of 150-300 ml/g, where the viscosity number is determined in a phenol/o-dichlorobenzene solution having a weight ratio of 1:1 and a thermostatic water bath at 25±0.05° C. in accordance with the regulations of GB/T 17931-1999.

Preferably, in the step S1, a catalyst based on 0.001-1% weight of the final semi-aromatic polyester is added in the preparation of the Ba2 esterified product. Preferably, the catalyst is added by 0.02-0.2% weight of the final semi-aromatic polyester. The adding amount of the catalyst is controlled to make the subsequent machining process more stable. Further, the catalyst may be a tin compound, an antimony compound, a cobalt compound, a lead compound, a zinc compound, an aluminium compound or a titanium compound; more preferably, a zinc compound, an aluminium compound or a titanium compound, more preferably, a titanium compound. Relative to other compounds, the titanium compound, for example, tetrabutyl ortho-titanate or tetraisopropyl ortho-titanate has the advantage of low toxicity of residues on the product or downstream products. Such a property is rather important in biodegradable polyurethanes because the compound will directly enter into the environment in a form of a composting bag or cover film.

The pressure in the process of the present invention is an absolute pressure (AP).

In the step S1, the total molar weight of the second component B is usually 1.1-3.0 times the first component A; the excessive amount of the second component B is recovered by a purification equipment (usually a rectifying tower) connected with an esterification reactor into the esterification reactor. The recovery amount of the second component B is usually 20-50 wt % of the amount of the fresh second component B.

In the step S2, the reaction temperature is more preferably 180-200° C. and the reaction pressure is more preferably 2-5 kPa during the preparation of a Pre-Ba1 prepolymer.

In the step S2, the remaining amount of catalyst in the step S1 may be added to the step S2 if necessary during the preparation of a Pre-Ba2 prepolymer. The reaction temperature is more preferably 240-260° C. and the reaction pressure is more preferably 2-5 kPa.

In the step S2, when Pre-Ba1 and Pre-Ba2 are prepared respectively, the general reaction time is 2-5 h. Under normal conditions, the reaction products Pre-Ba1 and Pre-Ba2 of the primary polycondensation may be produced after the reaction time; the reaction products have a viscosity number of 15-60 ml/g, and the viscosity number is determined in a phenol/o-dichlorobenzene solution having a weight ratio of 1:1 and a thermostatic water bath at 25±0.05° C. in accordance with the regulations of GB/T 17931-1999. The reaction products Pre-Ba1 and Pre-Ba2 of the primary polycondensation after the S2 reaction generally have a carboxyl group content of 10-60 mmol/kg.

In the steps of the S3 polycondensation, a passivator may be mixed with a pre-polyester if necessary. The available passivator is usually a compound of phosphorus, including phosphoric acid, phosphorous acid and esters thereof. Based on the weight of the final polyester, the passivator usually has an amount of 0.001-0.1 wt %, preferably 0.01-0.05 wt %.

In the step S3, the reaction temperature is more preferably 190-220° C. and the reaction pressure is more preferably 50-200 Pa during the preparation of the Pre-Ba1 prepolymer.

In the step S3, the reaction temperature is more preferably 240-260° C. and the reaction pressure is more preferably 20-100 Pa during the preparation of the Pre-Ba2 prepolymer.

In the step S3, the polycondensation time is preferably 1-5 h, and more preferably 2-4 h. The produced polyesters Poly-Ba1 and Poly-Ba2 have a viscosity number of 50-180 ml/g; the viscosity number is determined in a phenol/o-dichlorobenzene solution having a weight ratio of 1:1 and a thermostatic water bath at 25±0.05° C. in accordance with the regulations of GB/T 17931-1999. Moreover, the polyesters Poly-Ba1 and Poly-Ba2 after the S3 reaction usually have a carboxyl group content of 5-60 mmol/kg, and more preferably, a carboxyl group content of 10-30 mmol/kg.

In the step S4, Poly-Ba1 and Poly-Ba2 are mixed in a mixer; the mixer includes a raw material injection system, a temperature control system, a high-shear homogenization pump, and a homogenizer; the mixer has a temperature range of 200° C.-280° C., preferably, 240° C.-260° C.; the retention time of the Poly-Ba1 and Poly-Ba2 in the mixer is 1-4 h, and preferably 1.5-2 h. The reaction product obtained after through the mixer has a viscosity number of 150-300 ml/g, and the viscosity number is determined in a phenol/o-dichlorobenzene solution having a weight ratio of 1:1 and a thermostatic water bath at 25±0.05° C. in accordance with the regulations of GB/T 17931-1999.

Preferably, the present invention further includes a step S5 if necessary: adding the semi-aromatic polyester obtained in the step S4 to the fourth component D for chain propagation reaction at a reaction temperature of 200-270° C. until the reaction product has a viscosity number of 150-350 ml/g, where the viscosity number is determined in a phenol/o-dichlorobenzene solution having a weight ratio of 1:1 and a thermostatic water bath at 25±0.05° C. in accordance with the regulations of GB/T 17931-1999, and the reaction retention time is 0.5-15 min, and preferably, 2-5 min.

In the process of the present invention, the aliphatic diacid and aromatic diacid are independently subjected to polymerization reaction respectively before the chain extension stage, and the aliphatic polyester oligomer and aromatic polyester oligomer are not mixed until the chain extension stage. The prepared semi-aromatic polyester has a double bond content of 0.55-4.5 mmol/kg such that the semi-aromatic polyester has better melting heat retention stability and fine color.

The double bond content in the semi-aromatic polyester of the present invention may be further controlled within 0.55-4.5 mmol/kg by other processes, for example, by the direct copolymerization of double bond-containing compounds (e.g., undecylenic acid) during the synthesis.

The present invention further provides an application of the above semi-aromatic polyester in preparing a compostable degradation product, and the compostable degradation product may be a fiber, a film or a container.

The present invention further provides a semi-aromatic polyester molding composition, including the following components by weight percentage:
5-95 wt % of the above semi-aromatic polyester;
5-95 wt % of an additive and/or other polymers;
0-70 wt % of a reinforcing material and/or a filler.

As a specific option, the additive and/or other polymers may be, at least one or more of components selected from an aliphatic polyester, polycaprolactone, starch, cellulose, poly-hydroxyalkanoate and polylactic acid.

Compared with the prior art, the prevent invention has the following beneficial effects:

The present invention discloses a semi-aromatic polyester. The semi-aromatic polyester has a specific double bond content. Compared with the existing semi-aromatic polyesters, the semi-aromatic polyester of the present invention has better melting heat retention stability and fine color.

### BRIEF DESCRIPTION OF THE DRAWINGS

FIG. 1 is a ¹H NMR diagram of a semi-aromatic polyester obtained in Example 1;

FIG. 2 is an enlarged diagram showing a portion of double bond peaks in the ¹H NMR spectrum of the semi-aromatic polyester obtained in Example 1.

### DETAILED DESCRIPTION OF THE EMBODIMENTS

Raw materials, reagents and solvents used in the present invention are commercial available without any treatment, unless otherwise stated. The present invention will be further specifically described with reference to the examples. The embodiments of the present invention are not limited to the following examples. Any other changes, modifications, substitutions, combinations or simplifications made within the spirit and principle of the present invention shall be equivalent modes of replacement, and shall fall within the protection scope of the present invention. Moreover, the wording “part” and “%” in the description herein respectively represent “part by mass” and “mass %”.

### Performance Test Method:

Test method for the double bond content in the semi-aromatic polyester (PBAT obtained by reacting terephthalic acid with adipic acid and 1,4-butanediol in Example 1 was set as an example):

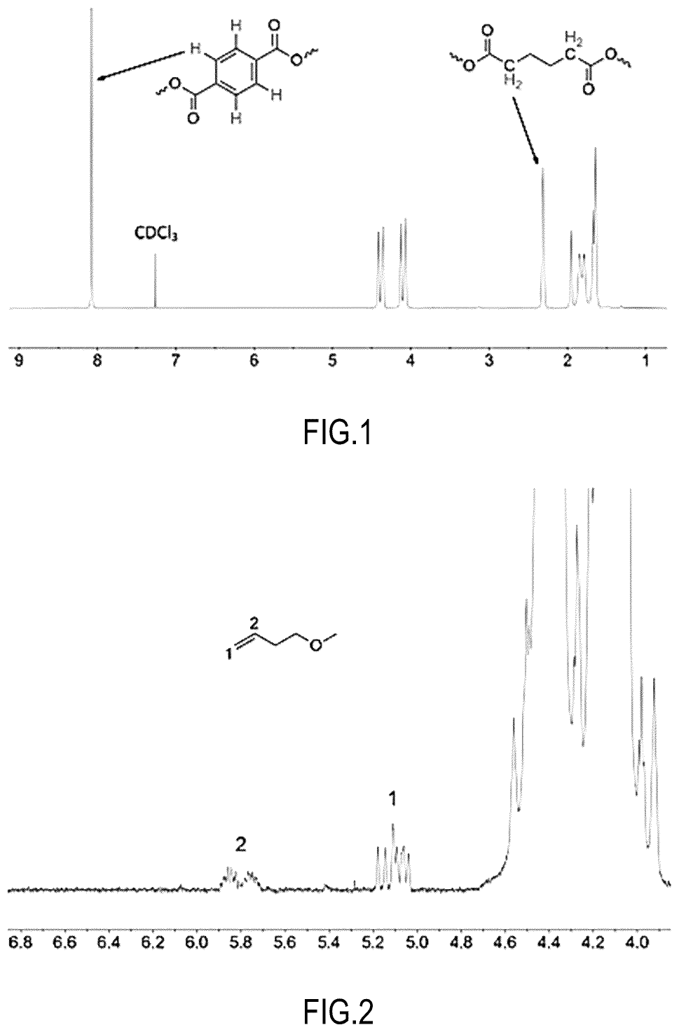

20 mg of the semi-aromatic polyester samples were taken and dissolved into 0.6 ml of deuterated chloroform, and then ¹H NMR was determined by an AV 500 nuclear magnetic resonance spectrometer from Bruker to calibrate a chloroform solvent peak of 7.26 ppm. As can be seen from the Reference (J. Appl. Polym. Sci. 2007, 104(4): 2643-2649.), 4 hydrogen atoms on the benzene ring in the repeating unit of terephthalic acid appeared nearby the 8.10 ppm; and 4 hydrogen atoms on the two CH₂ units adjacent to the carbonyl group in the repeating unit of adipic acid appeared nearby the 2.33 ppm, as shown in FIG. 1. The molar weight of the diacid component may be represented by the integral areas (I_{T} and I_{A}) of the two peaks at 8.10 ppm and 2.33 ppm:

$$molar weight of terephthalic acid in PBAT = {I}_{T} / ( {I}_{T} + {I}_{A} ) \times 100 \%$$

$$molar weight of adipic acid in PBAT = {I}_{A} / ( {I}_{T} + {I}_{A} ) \times 100 \%$$

As can be seen from the ¹H NMR spectrum of 3-butene-1-ol (CAS: 627-27-0) in references and SDBS database, the peak 1 at 5.0-5.2 ppm is the peak of CH₂═CH— of the two hydrogen atoms on the methylene at the terminal ends of the double bond; the peak 2 at 5.7-5.9 ppm is the peak of CH₂═CH— of the hydrogen atoms on the methine at the terminal ends of the double bond, as shown in FIG. 2.

As the semi-aromatic polyester has a lower double bond content, the peak of the two hydrogen atoms on the methylene at the terminal ends of the double bond are used as the calculation basis to obtain a calculation formula of the double bond content C (unit: mmol/kg):

$$C = \frac{\frac{{I}_{1}}{2}}{\frac{{I}_{T} + {I}_{A}}{4} \times {M}_{0}} \times 1 {0}^{6} = \frac{2 {I}_{1}}{( {I}_{T} + {I}_{A} ) \times {M}_{0}} \times 1 {0}^{6}$$

in which,
I₁ is an integral area of a CH₂=CH— peak of the two hydrogen atoms on the methylene at terminal ends of the double bond;
I_{T} is an integral area of the four hydrogen atoms on the benzene ring of the terephthalic acid repeating unit;
I_{A} is an integral area of the four hydrogen atoms on the two —CH₂— connected with the carbonyl group on the adipic acid repeating unit;
M₀ is an average molecular weight of a PBAT single repeating unit of the semi-aromatic polyester;
for example, when the molar ratio of terephthalic acid to adipic acid in Example 1 is 0.467:0.533, the average molecular weight M₀ of the repeating unit is: M₀=0.467*MPBT+0.533*MPBA. If MPBT is a molecular weight of 220 g/mol of the PBT repeating unit and MPBA is a molecular weight of 200 g/mol of the PBA repeating unit, the PBAT repeating unit in the semi-aromatic polyester of Example 1 is M₀=209 g/mol.

The viscosity number of the semi-aromatic polyester is:
determined in a phenol/o-dichlorobenzene solution having a weight ratio of 1:1 and a thermostatic water bath at 25±0.05° C. in accordance with the regulations of GB/T 17931-1999; the sample concentration is 5 mg/ml.

### Carboxyl Group Content:

An acid value AN (mg KOH/g) was firstly determined according to DIN EN 12634 in October 1998, and then the carboxyl group content (mmol/kg)=AN/56×10³. The solvent mixture used included 1 part by volume of DMSO, 8 parts by volume of isopropanol and 7 parts by volume of toluene. The semi-aromatic polyester sample was heated up to 70° C. such that all the polymers were dissolved into a clear solution; the solution temperature was kept within 60-70° C. during titration to avoid the precipitation of the polymers. Tetrabutyl ammonium hydroxide is used as a titrant to avoid the highly toxic tetramethylammonium hydroxide. Meanwhile, to prevent the mixed solvent from absorbing CO₂ in the air to affect the volume of the titrant consumed by the blank solvent, when the volume of the titrant consumed by the blank solvent was determined, the blank solvent was heated up to a constant temperature of 70° C. for 0.5 h, then the blank solvent was titrated with an alkali solution immediately, thus preventing the heated blank solvent from further absorbing CO₂ in the air.

### Test on the Melting Heat Retention Stability:

The melt mass flow rate (MFR) of the semi-aromatic polyester was tested by reference to the Part 1: Standard Method of the GB/T 3682.1-2018 Determination of the Melt Mass Flow Rate (MFR) and of Melt Volume Flow Rate (MVR) of Thermoplastic Plastics. The test temperature was 190° C. and load was 2.16 kg. A melt index was obtained at a melt time of 5 min, denoted as MFR₀; and a melt index was obtained at a melt time of 20 min, denoted as MFR₁. A retention rate of the heat retention melt index R=MFR₀/MFR₁×100% was obtained. The lower the R value is, the worse the heat retention stability is.

### Color of the Semi-Aromatic Polyester:

Pelletized and dried samples were taken and tested according to the GB/T 14190-2017 5.5.2 Method B (Drying Method). L, a and b values of the Hunter Lab color system were tested to define a Hunter whiteness:

$$WH = 100 - {[ {( 100 - L )}^{2} + {a}^{2} + {b}^{2} ]}^{1 / 2}$$

The greater the Hunter whiteness is, the better the sample color is.

### Example 1

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 44 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 27 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 138 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 115 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Example 2

Step S1, 605 kg/h decanedioic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 180° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 190° C., a pressure of 4 kPa and a retention time of 2-3 h; the excessive butanediol was moved out; at this time, the reaction product Pre-Ba1 had a viscosity number of 46 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 29 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 210° C., a pressure of 120 Pa and a retention time of 2-4 h. At this time, the reaction product Poly-Ba1 had a viscosity number of 147 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 119 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.4 h. Afterwards, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Example 3

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.88 kg/h trimethylolpropane (TMP) and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.772 kg/h trimethylolpropane and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 42 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 25 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 129 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 111 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Example 4

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.224 kg/h titanium tetrabutoxide was added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.406 kg/h titanium tetrabutoxide was added to control a pressure of the reactor to be 40 kPa (absolute pressure) and a temperature to be 240° C., and the retention time was 2-4 h; water, tetrahydrofuran and butanediol generated by the reaction were removed to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 49 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 35 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 141 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 120 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Example 5

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 42 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 28 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 140 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 125 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 11.2 kg/h N,N′-di(2,6-diisopropylphenyl)carbodiimide (Stabaxol I) was metered and added, and temperature was set as 240° C. 3 min later after the retention time, the polyester was granulated by an underwater granulator, and dried to obtain the final polyester product.

### Example 6

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
600 kg/h terephthalic acid and 488 kg/h 1,4-butanediol were continuously added to a slurry preparation kettle, and the prepared slurry was continuously fed into a second esterification reactor, and another pathway of 1,4-butanediol from the bottom of the process tower had a flow rate of 163 kg/h, meanwhile, 0.73 kg/h glycerin and 0.56 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed; the obtained esterified product A1 was continuously extracted from the reaction kettle to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 47 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.24 kg/h titanium tetrabutoxide and 0.60 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 35 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 132 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 119 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 6.11 kg/h hexamethylene diisocyanate (HDI) was metered and added, and temperature was set as 240° C. 3 min later after the retention time, the polyester was granulated by an underwater granulator, and dried to obtain the final polyester product.

### Example 7

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed; the obtained esterified product A1 was continuously extracted from the reaction kettle to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 40 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 29 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 130 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 114 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 5.2 kg/h hexamethylene diisocyanate (HDI) was metered and added, and temperature was set as 240° C. 6 min later after the retention time, the polyester was granulated by an underwater granulator, and dried to obtain the final polyester product.

### Example 8

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed; the obtained esterified product A1 was continuously extracted from the reaction kettle to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 43 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 25 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 133 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 112 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 1.5 h. Afterwards, the obtained polyester was brought into a twin-screw extruder, and meanwhile, 5.2 kg/h hexamethylene diisocyanate (HDI) was metered and added, and temperature was set as 240° C. 12 min later after the retention time, the polyester was granulated by an underwater granulator, and dried to obtain the final polyester product.

### Example 9

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed; the obtained esterified product A1 was continuously extracted from the reaction kettle to obtain an esterified product Ba2;
step S2, the esterified product Ba1 was transferred to a first pre-polycondensation reaction kettle, and meanwhile 0.096 kg/h titanium tetrabutoxide and 0.245 kg/h triphenyl phosphate were added; the reaction kettle had a temperature of 200° C., a pressure of 4 kPa and a retention time of 2-3 h; the excessive butanediol was moved out; at this time, the reaction product Pre-Ba1 had a viscosity number of 47 ml/g; the viscosity number was determined in a phenol/o-dichlorobenzene solution having a weight ratio of 1:1 and a thermostatic water bath at 25±0.05° C. in accordance with the regulations of GB/T 17931-1999;
the esterified product Ba2 was transferred to a second pre-polycondensation reaction kettle, and meanwhile 0.174 kg/h titanium tetrabutoxide and 0.44 kg/h triphenyl phosphate were added; the reaction kettle had a temperature of 250° C., a pressure of 2 kPa and a retention time of 2-3 h; the excessive butanediol was moved out; at this time, the reaction product Pre-Ba2 had a viscosity number of 29 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-Ba1 was fed into a first final-polycondensation kettle by a melt pump; the first final-polycondensation kettle had a temperature of 220° C., a pressure of 120 Pa and a retention time of 2-4 h. At this time, the reaction product Poly-Ba1 had a viscosity number of 136 ml/g and the viscosity number was determined in a phenol/o-dichlorobenzene solution having a weight ratio of 1:1 and a thermostatic water bath at 25±0.05° C. in accordance with the regulations of GB/T 17931-1999;
the prepolymer Pre-Ba2 was fed into a second final-polycondensation kettle by a melt pump; the second final-polycondensation kettle had a temperature of 250° C., a pressure of 20 Pa and a retention time of 2-4 h. At this time, the reaction product Poly-Ba2 had a viscosity number of 120 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the two final-polycondensation products Poly-Ba1 and Poly-Ba2 were continuously fed into a mixer, and the mixer had a temperature of 250° C. and a retention time of 2 h. Afterwards, the polyester was granulated by an underwater granulator, and dried to obtain the final polyester product.

### Example 10

1951 g paraphthaloyl chloride, 2000 g adipoyl chloride and 0.73 g undecylenoyl chloride (CAS: 38460-95-6) were dissolved into 2000 ml dichloromethane under the protection of high-purity nitrogen to obtain an acyl chloride solution, then the solution was kept in an ice bath and cooled to 0° C. for further use. 1890 g 1,4-butanediol and 4240 g triethylamine were added to 3000 ml dichloromethane, and stirred evenly to obtain an alkanolamine solution. The above alkanolamine solution was dropwisely added to the acyl chloride solution slowly to control the dropping rate such that the solution temperature was controlled within 3° C., and the dropwise addition was completed for about 1 h. The ice bath was removed at the end of the dropwise addition, and the remaining solution was stirred for reaction for 24 h at room temperature. The product was dropwisely added to a mixed solution of triethylamine and ethanol (a volume ratio of 1:2) to generate white precipitate, standing was performed, after the precipitation was completed, suction filtration was performed. The solution was washed for several times by the mixed solution of triethylamine and ethanol and deionized water, respectively, and finally put to a vacuum oven at 70° C. for drying for 10 h, thus obtaining a powdery polymer. The powdery polymer was extruded and granulated with a twin-screw extruder at an extruding temperature of 240° C., cooled with water and dried to obtain the final polyester product.

### Comparative Example 1

Step S1, 437 kg/h terephthalic acid, 437 kg/h adipic acid, 760 kg/h 1,4-butanediol, 1.13 kg/h glycerin and 0.63 kg/h tetrabutyl ortho-titanate were continuously added to a slurry preparation kettle, and the prepared slurry was continuously fed into an esterification reactor, and another pathway of 1,4-butanediol from the bottom of the process tower had a flow rate of 253 kg/h, meanwhile, a pressure of the reactor was controlled to be 40 kPa (absolute pressure) and a temperature was controlled to be 240° C., and the retention time was 2-4 h; water, tetrahydrofuran and butanediol generated by the reaction were removed to obtain an esterified product BA;
step S2, the esterified product BA was brought into to a pre-polycondensation reaction kettle by gravity, and meanwhile 0.27 kg/h titanium tetrabutoxide and 0.685 kg/h triphenyl phosphate were added; the reaction kettle had a temperature of 250° C., a pressure of 2 kPa and a retention time of 2-3 h; the excessive butanediol was moved out; at this time, the reaction product Pre-BA had a viscosity number of 39 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-BA was fed into a disc-type reactor (namely, a final-polycondensation kettle) by a melt pump; the final-polycondensation kettle had a temperature of 250° C., a pressure of 20 Pa and a retention time of 2-4 h. At this time, the reaction product Poly-BA had a viscosity number of 133 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Comparative Example 2

Step S1, 437 kg/h adipic acid and 404 kg/h 1,4-butanediol were continuously added to a slurry preparation kettle, and the prepared slurry was continuously fed into a first esterification reactor, and another pathway of 1,4-butanediol from the bottom of the process tower had a flow rate of 135 kg/h, meanwhile, 0.60 kg/h glycerin and 0.224 kg/h titanium tetrabutoxide were added to control a pressure of the reactor to be 40 kPa (absolute pressure) and a temperature to be 190° C., and the retention time was 2-4 h; water, tetrahydrofuran and butanediol generated by the reaction were removed to obtain an esterified product Ba1;
437 kg/h terephthalic acid and 356 kg/h 1,4-butanediol were continuously added to a slurry preparation kettle, and the prepared slurry was continuously fed into a second esterification reactor, and another pathway of 1,4-butanediol from the bottom of the process tower had a flow rate of 119 kg/h, meanwhile, 0.53 kg/h glycerin and 0.406 kg/h titanium tetrabutoxide were added to control a pressure of the reactor to be 40 kPa (absolute pressure) and a temperature to be 240° C., and the retention time was 2-4 h; water, tetrahydrofuran and butanediol generated by the reaction were removed; the obtained esterified product A1 was continuously extracted from the reaction kettle to obtain an esterified product Ba2;
step S2, the two esterified products Ba1 and Ba2 were continuously fed into a mixer, and the mixer had a temperature of 230° C. and a retention time of 30 min. The mixture flowing out of the mixer was brought into to a pre-polycondensation reaction kettle by gravity, and meanwhile 0.27 kg/h titanium tetrabutoxide and 0.685 kg/h triphenyl phosphate were added; the reaction kettle had a temperature of 250° C., a pressure of 2 kPa and a retention time of 2-3 h; the excessive butanediol was moved out; at this time, the reaction product Pre-BA had a viscosity number of 37 ml/g; the viscosity number was determined in a phenol/o-dichlorobenzene solution having a weight ratio of 1:1 and a thermostatic water bath at 25±0.05° C. in accordance with the regulations of GB/T 17931-1999;
step S3, the prepolymer Pre-BA was fed into a disc-type reactor (namely, a final-polycondensation kettle) by a melt pump; the final-polycondensation kettle had a temperature of 250° C., a pressure of 20 Pa and a retention time of 2-4 h. At this time, the reaction product Poly-BA had a viscosity number of 128 ml/g and the viscosity number was determined in a phenol/o-dichlorobenzene solution having a weight ratio of 1:1 and a thermostatic water bath at 25±0.05° C. in accordance with the regulations of GB/T 17931-1999;
step S4, the obtained polyester was brought into a twin-screw extruder, and meanwhile, 5.2 kg/h hexamethylene diisocyanate (HDI) was metered and added, and temperature was set as 240° C. 3 min later after the retention time, the polyester was granulated by an underwater granulator, and dried to obtain the final polyester product.

### Comparative Example 3

2.36 kg terephthalic acid, 2.36 kg adipic acid, 4.38 kg 1,4-butanediol, 6.1 g glycerin and 4.9 g titanium tetrabutoxide were fed into a reaction kettle under the protection of high-purity nitrogen, and heated up to 240° C., and kept at the constant temperature for 120 min. 3.7 g triphenyl phosphate was then added. The pressure in the reaction kettle was reduced to 50 Pa below within 60 min, and reaction was performed for 60-120 min at 260° C. Afterwards, high-purity nitrogen was pumped into the reaction kettle, and 28.1 g hexamethylene diisocyanate (HDI) was added and stirred for 5 min at a constant temperature of 260° C., and then discharged.

TABLE 1
Performance test results of Examples 1-10 and Comparative Examples 1-3

| | Example | Example | Example | Example | Example | Example | Example |
|---|---|---|---|---|---|---|---|
| | 1 | 2 | 3 | 4 | 5 | 6 | 7 |
| Branching agent | Glycerin | Glycerin | TMP | 0 | Glycerin | Glycerin | Glycerin |
| Chain extender | HDI | HDI | HDI | HDI | Stabaxol I | HDI | HDI |
| Retention time of the | 3 | 3 | 3 | 3 | 3 | 3 | 6 |
| chain extension/min | | | | | | | |
| Terephthalic | 46.7 | 46.9 | 46.6 | 46.5 | 46.8 | 54.8 | 46.9 |
| acid/mol % | | | | | | | |
| Adipic acid/mol % | 53.3 | | 53.4 | 53.5 | 53.2 | 46.2 | 53.1 |
| Decanedioic | | 53.1 | | | | | |
| acid/mol % | | | | | | | |
| Double bond content | 0.79 | 0.85 | 0.81 | 0.82 | 0.81 | 0.82 | 2.2 |
| C/mmol/kg | | | | | | | |
| Carboxyl | 22 | 26 | 23 | 24 | 12 | 23 | 35 |
| group/mmol/kg | | | | | | | |
| Viscosity | 205 | 207 | 209 | 192 | 210 | 207 | 220 |
| number/ml/g | | | | | | | |
| Retention rate R of | 89 | 82 | 87 | 85 | 85 | 88 | 73 |
| heat retention melt | | | | | | | |
| index/% | | | | | | | |
| Hunter whiteness | 82.3 | 80.2 | 81.9 | 81.6 | 80.6 | 81.1 | 76.3 |

| | Example | Example | Example | Comparative | Comparative | Comparative |
|---|---|---|---|---|---|---|
| | 8 | 9 | 10 | Example 1 | Example 2 | Example 3 |
| Branching agent | Glycerin | Glycerin | — | Glycerin | Glycerin | Glycerin |
| Chain extender | HDI | 0 | — | HDI | HDI | HDI |
| Retention time of the | 12 | — | — | 3 | 3 | 5 |
| chain extension/min | | | | | | |
| Terephthalic | 46.6 | 46.7 | 46.7 | 46.5 | 46.8 | 46.4 |
| acid/mol % | | | | | | |
| Adipic acid/mol % | 53.4 | 53.3 | 53.3 | 53.5 | 53.2 | 53.6 |
| Double bond content | 4.1 | 1.24 | 0.84 | 10.6 | 8.3 | 11.1 |
| C/mmol/kg | | | | | | |
| Carboxyl | 41 | 29 | 29 | 33 | 30 | 34 |
| group/mmol/kg | | | | | | |
| Viscosity number/ml/g | 201 | 179 | 180 | 210 | 208 | 203 |
| Retention rate R of | 71 | 77 | 83 | 56 | 62 | 54 |
| heat retention melt | | | | | | |
| index/% | | | | | | |
| Hunter whiteness | 75.6 | 78.8 | 80.1 | 66.8 | 70.9 | 65.4 |

It can be seen from the above results that in this present invention, the double bond content of the semi-aromatic polyester is controlled within a scope of 0.55-4.5 mmol/kg; the retention rate of heat retention melt index is high, the Hunter whiteness is high and color is fine.

Mixed esterification step is used in the whole process of Comparative Example 1; the higher polymerization temperature enables the portion derived from aliphatic polyester in the semi-aromatic polyester to be thermally degraded easily; the obtained double bond content is high, the retention rate of heat retention melt index is low, and color is poor.

In Comparative Example 2, the aliphatic polyester and the aromatic polyester are esterified independently, but still mixed after the esterification, which has certain effects on reducing the double bond content and improving the retention rate of heat retention melt index and color. However, the reaction time of the esterification stage accounts for a low proportion in the whole polymerization reaction; therefore, the improvement effect is limited.

Intermittent process is used in Comparative Example 3 for production; the obtained double bond content is high, and the retention rate of heat retention melt index is low and color is poor.

1. A semi-aromatic polyester, derived from a repeating unit consisting of the following components:
a first component A, based on a total molar weight of the first component A, comprising:
a component a1) 40-60 mol % of at least one aliphatic dicarboxylic acid or a derivative thereof;
a component a2) 40-60 mol % of at least one aromatic dicarboxylic acid or a derivative thereof;
a second component B: comprising a diol having 2-12 carbon atoms;
wherein double bonds in the semi-aromatic polyester have a content of 0.55-4.5 mmol/kg.

2. The semi-aromatic polyester according to claim 1, wherein the component a1) is selected from one or a mixture of several of oxalic acid, propandioic acid, succinic acid, glutaric acid, adipic acid, heptanedioic acid, octanedioic acid, azelaic acid, decanedioic acid, 1,11-undecanedicarboxylic acid, 1,10-decanedicarboxylic acid, undecandioic acid, 1,12-dodecanedicarboxylic acid, hexadecane diacid, eicosandioic acid, tetracosandioic acid or an ester derivative thereof or an anhydride derivative thereof.

3. The semi-aromatic polyester according to claim 1, wherein the component a2) is selected from one or a mixture of several of terephthalic acid, iso-phthalic acid, naphthalenedicarboxylic acid, or an ester derivative thereof or an anhydride derivative thereof.

4. The semi-aromatic polyester according to claim 1, wherein the second component B is selected from one or more of ethanediol, 1,3-propanediol, 1,4-butanediol, 1,5-pentanediol, 1,6-hexanediol, 1,9-nonanediol, 1,10-decanediol, 1,11-undecanediol, 1,12-dodecanediol, 1,4-cyclohexanediol, and 1,4-cyclohexanedimethanol.

5. The semi-aromatic polyester according to claim 1, wherein the component a1) is selected from adipic acid or the ester derivative thereof or the anhydride derivative thereof; the component a2) is terephthalic acid or the ester derivative thereof or the anhydride derivative thereof; and the second component B is 1,4-butanediol.

6. The semi-aromatic polyester according to claim 1, wherein based on the total molar weight of the first component A, the semi-aromatic polyester further comprises a third component C of 0.01-5.0 mol %, and a fourth component D of 0.01-5.0 mol %.

7. The semi-aromatic polyester according to claim 6, wherein the third component C is selected from one or more of tartaric acid, citric acid, malic acid, trimethylolpropane, trimethylolethane, pentaerythritol, polyether triol, glycerol, 1,3,5-trimesic acid, 1,2,4-trimesic acid, 1,2,4-trimellitic anhydride, 1,2,4,5-prenitic acid or pyromellitic acid dianhydride.

8. The semi-aromatic polyester according to claim 6, wherein the fourth component D is selected from one or more of isocyanate, isocyanurate, peroxide, epoxide, oxazoline, oxazine, lactam, carbodiimide or polycarbodiimide which contains two or more functional groups.

9. The semi-aromatic polyester according to claim 1, wherein the semi-aromatic polyester has a viscosity number of 150-350 ml/g, and the viscosity number is determined in a phenol/o-dichlorobenzene solution having a weight ratio of 1:1 and a thermostatic water bath at 25±0.05° C. in accordance with the regulations of GB/T 17931-1999.

10. The semi-aromatic polyester according to claim 1, wherein the semi-aromatic polyester has a carboxyl group content of 5-60 mmol/kg.

11. A preparation method of the semi-aromatic polyester according to claim 1, comprising the following steps:
step S1: adding the component a1 in the first component A and the second component B to a slurry preparation kettle by a proportion, and transporting the prepared slurry to a first esterification reactor, then adding the second component B returned and a catalyst to the first esterification reactor from another pathway, and performing esterification reaction for 2-4 h at 150-200° C. and 30-110 kPa to obtain an esterified product Ba1; adding the component a2 in the first component A and the second component B to a slurry preparation kettle, and transporting the prepared slurry to a second esterification reactor, then adding the second component B returned and a catalyst to the second esterification reactor from another pathway, and performing esterification reaction for 2-4 h at 200-250° C. and 30-110 kPa to obtain an esterified product Ba2;
step S2: performing primary polycondensation on the esterified product Ba1 in the step S1 at a reaction temperature of 170-220° C. and a pressure of 1-10 kPa; performing primary polycondensation on the esterified product Ba2 in the step S1 at a reaction temperature of 230-270° C. and a pressure of 1-10 kPa; performing the primary polycondensation on the esterified products Ba1 and Ba2 independently and respectively until each reaction product has a viscosity number of 15-60 ml/g, wherein the viscosity number is determined in a phenol/o-dichlorobenzene solution having a weight ratio of 1:1 and a thermostatic water bath at 25±0.05° C. in accordance with the regulations of GB/T 17931-1999, thus respectively obtaining products Pre-Ba1 and Pre-Ba2 of the primary polycondensation;
step S3: transferring the product Pre-Ba1 of the primary polycondensation obtained in the step S2 to a first final-polycondensation kettle at a reaction temperature of 180-230° C. and a pressure of 10-500 Pa; transferring the product Pre-Ba2 of the primary polycondensation obtained in the step S2 to a second final-polycondensation kettle at a reaction temperature of 220-270° C. and a pressure of 10-500 Pa; performing polycondensation on the products Pre-Ba1 and Pre-Ba2 independently and respectively until each reaction product has a viscosity number of 50-180 ml/g, wherein the viscosity number is determined in a phenol/o-dichlorobenzene solution having a weight ratio of 1:1 and a thermostatic water bath at 25±0.05° C. in accordance with the regulations of GB/T 17931-1999, thus respectively obtaining final-polycondensation products Poly-Ba1 and Poly-Ba2;
step S4: performing mixed reaction on the final-polycondensation products Poly-Ba1 and Poly-Ba2 obtained in the step S3 in a mixer to obtain the semi-aromatic polyester such that the semi-aromatic polyester has a viscosity number of 150-300 ml/g, wherein the viscosity number is determined in a phenol/o-dichlorobenzene solution having a weight ratio of 1:1 and a thermostatic water bath at 25±0.05° C. in accordance with the regulations of GB/T 17931-1999.

12. The preparation method of the semi-aromatic polyester according to claim 11, further comprising step S5: adding the semi-aromatic polyester obtained in the step S4 to a fourth component D for chain propagation reaction at a reaction temperature of 200-270° C. until a reaction product has a viscosity number of 150-350 ml/g, wherein the viscosity number is determined in a phenol/o-dichlorobenzene solution having a weight ratio of 1:1 and a thermostatic water bath at 25±0.05° C. in accordance with the regulations of GB/T 17931-1999, and wherein the reaction retention time is 0.5-15 min.

13. A semi-aromatic polyester molding composition, comprising the following components by weight percentage:
5-95 wt % of the semi-aromatic polyester of claim 1;
5-95 wt % of an additive and/or other polymers;
0-70 wt % of a reinforcing material and/or a filler.

14. An application of the semi-aromatic polyester of claim 1 in preparing a compostable degradation product, wherein the compostable degradation product is a fiber, a film or a container.
